(19) United States
(12) Patent Application Publication
(10) Pub. No.: US 2021/0300340 A1
(43) Pub. Date: Sep. 30, 2021

(54) PREDETERMINED AREA MANAGEMENT DEVICE

(71) Applicant: HONDA MOTOR CO., LTD., Tokyo (JP)

(72) Inventors: Junpei NOGUCHI, Saitama (JP); Gaku SHIMAMOTO, Saitama (JP); Yuta TAKADA, Tokyo (JP); Ryoma TAGUCHI, Tokyo (JP)

(73) Assignee: HONDA MOTOR CO., LTD., Tokyo (JP)

(21) Appl. No.: 17/214,321

(22) Filed: Mar. 26, 2021

(30) Foreign Application Priority Data
Mar. 30, 2020 (JP) 2020-061633

(51) Int. Cl. B60W 30/06; G08G 1/14; G08G 1/017; G06Q 50/30; G06K 9/00

(52) U.S. Cl. CPC B60W 30/06; G08G 1/149; G06K 2209/23; G06Q 50/30; G06K 9/00785; G08G 1/017

(57) ABSTRACT

A predetermined area management device, configured to manage a predetermined area into which a moving body can enter, the predetermined area being an area in which the entering moving body automatically moves, the predetermined area management device includes: an acquisition unit configured to acquire information indicating the operation state of an automatic moving function of the moving body; an operation state determination unit configured to determine whether the automatic moving function of the moving body is in operation or in non-operation based upon the operation state; and a processing unit configured to perform processing of allowing or restricting the entry of the moving body into the predetermined area based upon the determination result of the operation state determination unit.

### CROSS-REFERENCE TO RELATED APPLICATIONS

The present application claims the benefit of priority of Japanese Patent Application No. 2020-061633, filed on Mar. 30, 2020, the content of which is incorporated herein by reference.

### TECHNICAL FIELD

The present invention relates to a predetermined area management device.

### BACKGROUND ART

In a related art, known is a technology for managing the entry of a vehicle having an automatic driving function into a parking lot. For example, JP-A-2018-60393 discloses a server device configured to transmit an entry command into a parking lot with respect to a vehicle when a parking lot map stored in the vehicle is the lasted version.

However, in the related-art technology, there is room for improvement in the viewpoint of allowing a moving body to smoothly move in a predetermined area where the moving body such as a vehicle or the like automatically moves. For example, a moving body whose automatic moving function is not in operation may enter a predetermined area, and thus, the moving body may hinder the smooth movement of other moving bodies in the predetermined area.

### SUMMARY

The present invention provides a predetermined area management device that can prevent a moving body, which may hinder smooth movement of other moving bodies in a predetermined area, from entering the predetermined area and allow the moving bodies to smoothly move in the predetermined area.

According to an aspect of the present invention, there is provided a predetermined area management device configured to manage a predetermined area into which a moving body can enter, the predetermined area being an area in which the entering moving body automatically moves, the predetermined area management device including: an acquisition unit configured to acquire information indicating the operation state of an automatic moving function of the moving body; an operation state determination unit configured to determine whether the automatic moving function of the moving body is in operation or in non-operation based upon the operation state; and a processing unit configured to perform processing of allowing or restricting the entry of the moving body into the predetermined area based upon the determination result of the operation state determination unit.

According to the aspect of the present invention, it is possible to prevent a moving body, which may hinder the smooth movement of other moving bodies in a predetermined area, from entering the predetermined area, and to allow the moving bodies to smoothly move in the predetermined area.

### BRIEF DESCRIPTION OF THE DRAWINGS

FIG. 1 is a diagram illustrating an example of a configuration of a vehicle system according to the embodiment;

FIG. 2 is a diagram illustrating an example of a parking lot managed by a parking lot management device;

FIG. 3 is a diagram illustrating an example of a configuration of the parking lot management device;

FIG. 4 is a flowchart illustrating an example of entry management processing performed by the parking lot management device; and

FIG. 5 is a flowchart illustrating an example of the entry management processing performed by the parking lot management device.

### DESCRIPTION OF EMBODIMENTS

Hereinafter, an embodiment of a predetermined area management device of the present invention will be described with reference to the accompanying drawings. In the following embodiment, an example in which a moving body in the present invention is as a vehicle and a predetermined area in the present invention is as a parking lot will be described. Further, in the following embodiment, an example in which the predetermined area management device of the present invention is as a parking lot management device for managing the parking lot will be described.

[Vehicle System]

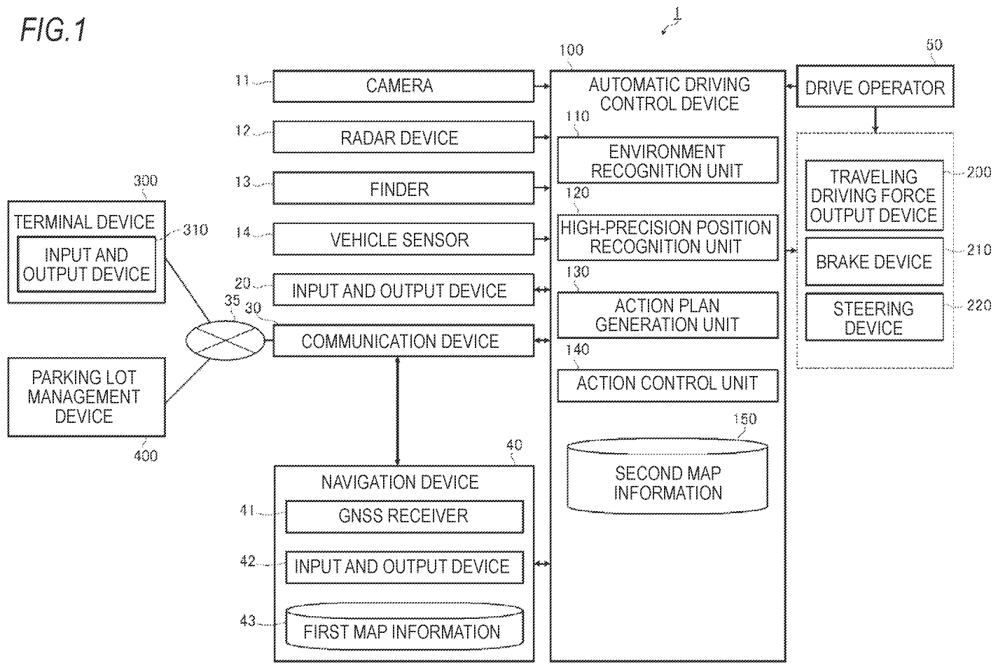

First, a vehicle of the embodiment will be described. In FIG. 1, a vehicle system 1 is mounted on the vehicle. The vehicle on which the vehicle system 1 is mounted (hereinafter, also referred to as a vehicle M) is an automobile including a drive source and wheels (for example, two wheels, three wheels, or four wheels) including a driving wheel driven by the power of the drive source. The drive source of the vehicle M is, for example, an electric motor. Further, the drive source of the vehicle M may be an internal combustion engine such as a gasoline engine or the like, and a combination of the electric motor and the internal combustion engine.

The vehicle system 1 has a function capable of performing all driving tasks related to the vehicle M at least in a limited specific area (for example, in a parking lot PA which will be described later). Here, the driving task is, for example, a real-time driving function required for controlling the vehicle M, such as controlling the left-right movement of the vehicle M (steering), controlling the movement in the front-rear direction (acceleration and deceleration), and monitoring the driving environment, and a tactical function such as planning of a traveling track, or the like.

As illustrated in FIG. 1, the vehicle system 1 includes, for example, a camera 11, a radar device 12, a finder 13, a vehicle sensor 14, an input and output device 20, a communication device 30, a navigation device 40, a driving operator 50, an automatic driving control device 100, a traveling driving force output device 200, a brake device 210, and a steering device 220. The respective devices are communicably connected to each other via a wired or wireless communication network. The communication network connecting the respective devices is, for example, a Controller Area Network (CAN).

The camera 11 is a digital camera that photographs the periphery of the vehicle M (for example, in front of the vehicle M), and outputs image data acquired by photographing to the automatic driving control device 100. The radar device 12 is, for example, a radar device using radio waves in a millimeter wave band, detects a position of an object in the vicinity of the vehicle M (for example, in front of, behind, and to the side of the vehicle M), and outputs the detection result thereof to the automatic driving control device 100.

The finder 13 is, for example, a Laser Imaging Detection and Ranging (LIDAR), uses a predetermined laser beam to measure the distance to the object (a target object) existing in the vicinity of the vehicle M (for example, in front of, behind, and to the side of the vehicle M), and outputs the measurement result to the automatic driving control device 100.

The vehicle sensor 14 includes, for example, a vehicle speed sensor that detects the speed of the vehicle M, an acceleration sensor that detects the acceleration of the vehicle M, an angular velocity sensor that detects the angular velocity around the vertical axis of the vehicle M, an orientation sensor that detects the direction of the vehicle M, or the like. Further, the vehicle sensor 14 includes a radio wave intensity sensor that detects the intensity of radio waves (that is, a communication intensity) used for communication by the communication device 30 which will be described later. The vehicle sensor 14 outputs the detection result of each sensor to the automatic driving control device 100.

The input and output device 20 includes an output device that outputs various information to a user of the vehicle M (hereinafter, also simply referred to as a user) and an input device that receives various input operations from the user of the vehicle M. The output device of the input and output device 20 is, for example, a display that performs displaying based upon the processing result of the automatic driving control device 100. The output device may be a speaker, a buzzer, an indicator light, or the like. Further, the input device of the input and output device 20 is, for example, a touch panel and an operation button (a key, a switch, or the like) that outputs an operation signal corresponding to the input operation received from the user to the automatic driving control device 100.

The communication device 30 is connected to a network 35 and communicates with another device provided outside the vehicle system 1 via the network 35. The network 35 is, for example, a mobile communication network, a Wi-Fi network, Bluetooth (registered trademark), Dedicated Short Range Communication (DSRC), or the like.

The communication device 30 communicates with, for example, a terminal device 300 of the user of the vehicle M and a parking lot management device 400 that manages the parking lot PA where the vehicle M can be parked. The terminal device 300 is, for example, a smartphone, a tablet terminal, or the like, and is an electronic device connected to the network 35 and including an input and output device 310. The input and output device 310 is, for example, a display that displays various information to the user, a touch panel that receives the input operation of the user, or the like. The parking lot PA and the parking lot management device 400 will be described later.

The navigation device 40 includes a Global Navigation Satellite System (GNSS) receiver 41 and an input and output device 42. Further, the navigation device 40 includes a storage device (not illustrated) such as a flash memory or the like, and first map information 43 is stored in the storage device. The first map information 43 is, for example, information representing a road shape by a link indicating a road and a node connected by the link.

Further, the first map information 43 may include information representing the curvature of the road and a Point Of Interest (POI).

The GNSS receiver 41 specifies the latitude and longitude of a point where the vehicle M is positioned as the position of the vehicle M based upon the signal received from a GNSS satellite. Further, the navigation device 40 may specify or correct the position of the vehicle M by an Inertial Navigation System (INS) using the output of the vehicle sensor 14.

The input and output device 42 includes an output device that outputs various information to the user of the vehicle M and an input device that receives various input operations from the user of the vehicle M. The output device of the input and output device 42 is, for example, a display that performs displaying based upon the processing result of the navigation device 40 (for example, displays a route on the map, which will be described later). Further, the input device of the input and output device 42 is, for example, a touch panel and an operation button (a key, a switch, or the like) that outputs the operation signal corresponding to the input operation received from the user to the navigation device 40. The input and output device 42 may be shared with the input and output device 20.

For example, the navigation device 40 determines a route from the position of the vehicle M specified by the GNSS receiver 41 to the destination inputted by the user (hereinafter, also referred to as the route on the map) with reference to the first map information 43. Next, the navigation device 40 guides the determined route on the map to the user by the input and output device 42. Further, the navigation device 40 outputs information indicating the position of the vehicle M specified by the GNSS receiver 41 and information indicating the determined route on the map to the automatic driving control device 100.

The navigation device 40 may be realized by a function of the terminal device 300. Further, for example, the communication device 30 may be configured to transmit the information indicating the position of the vehicle M and the destination inputted by the user to a server device (a navigation server) outside the vehicle system 1, such that the function of the navigation device 40 is realized by the server device.

The driving operator 50 includes an operator such as an accelerator pedal, a brake pedal, a shift lever, a steering wheel, a deformed steering wheel, a joystick, and the like. The driving operator 50 is provided with a sensor that detects the amount of the operation or presence or absence of operation on the driving operator 50. The detection result by the sensor of the driving operator 50 is outputted to a part or all of the automatic driving control device 100, the traveling driving force output device 200, the brake device 210, and the steering device 220.

The traveling driving force output device 200 outputs the traveling driving force (torque) for the vehicle M to travel to the driving wheel. The traveling driving force output device 200 includes, for example, an electric motor and an electric motor Electronic Control Unit (ECU) that controls the electric motor. The electric motor ECU controls the electric motor based upon the detection result by the sensor of the driving operator 50 (for example, the accelerator pedal) and control information from the automatic driving control device 100. Further, when the vehicle M includes an internal combustion engine and a transmission as a drive source, the traveling driving force output device 200 may include the internal combustion engine, the transmission, and the ECU that controls the internal combustion engine and the transmission.

The brake device 210 includes, for example, a brake caliper, a cylinder that transmits hydraulic pressure to the brake caliper, an electric motor that generates the hydraulic pressure in the cylinder, and a brake ECU. The brake ECU controls the electric motor of the brake device 210 based upon the detection result by the sensor of the driving operator 50 (for example, the brake pedal) and the control information from the automatic driving control device 100, and outputs the brake torque in accordance with a braking operation to each wheel.

The steering device 220 includes, for example, a steering ECU and an electric motor. The electric motor of the steering device 220 changes the direction of the steering wheel by, for example, applying a force to a rack and pinion mechanism. The steering ECU drives the electric motor of the steering device 220 based upon the detection result by the sensor of the driving operator 50 (for example, the steering wheel) and the control information from the automatic driving control device 100, and changes the direction of the steering wheel.

[Automatic Driving Control Device]

The automatic driving control device 100 includes an environment recognition unit 110, a high-precision position recognition unit 120, an action plan generation unit 130, and an action control unit 140. Further, the automatic driving control device 100 includes a storage device (not illustrated) realized by a flash memory or the like accessible to each functional unit (for example, the high-precision position recognition unit 120) of the automatic driving control device 100, and second map information 150 is stored in the storage device.

The second map information 150 is more accurate map information than the first map information 43. The second map information 150 includes, for example, information indicating the center of a lane, information indicating a lane boundary line (for example, a road lane marking), and the like. Further, the second map information 150 may include road information, traffic regulation information, address information, facility information, telephone number information, and the like.

Further, the second map information 150 may be updated at any time when the communication device 30 communicates with another device. For example, when the vehicle M enters the parking lot PA, the communication device 30 receives information indicating a lane in the parking lot PA, a position of each parking space, and the like (hereinafter, also referred to as map information in the parking lot) from the parking lot management device 400. Next, the automatic driving control device 100 updates the second map information 150 to incorporate the received map information in the parking lot into the second map information 150. As a result, the automatic driving control device 100 can specify the position of each parking space in the parking lot PA, or the like with reference to the second map information 150.

The environment recognition unit 110 performs sensor fusion processing on the information to be acquired by a part or all of the camera 11, the radar device 12, and the finder 13, recognizes an object existing in the vicinity of the vehicle M and also recognizes the position of the object. The environment recognition unit 110 recognizes, for example, obstacles, road shapes, traffic lights, guardrails, utility poles, surrounding vehicles (including the traveling status such as the speed, the acceleration, or the like, and parking state), lane marks, pedestrians, or the like, and also recognizes positions thereof.

The high-precision position recognition unit 120 recognizes the detailed position and posture of the vehicle M with reference to the position of the vehicle M specified by the navigation device 40, the detection result by the vehicle sensor 14, the image photographed by the camera 11, the second map information, or the like. The high-precision position recognition unit 120 recognizes, for example, the traveling lane on which the vehicle M is traveling, or recognizes a relative position a posture of the own vehicle with respect to the traveling lane. Further, the high-precision position recognition unit 120 also recognizes, for example, the position of the vehicle M in the parking lot PA, or the like.

The action plan generation unit 130 generates an action plan of the vehicle M. Specifically, the action plan generation unit 130 generates a target track on which the vehicle M will travel in the future as the action plan of the vehicle M. For example, the target track is information represented by arranging points (track points) to be reached by the vehicle M for each predetermined traveling distance (for example, about several [m]). Further, the target track may include information on speed elements such as the target speed, the target acceleration, or the like of the vehicle M at each predetermined time or at each track point. The action plan generation unit 130 generates the action plan, for example, according to an instruction of the parking lot management device 400 received by the communication device 30.

The action control unit 140 controls the vehicle M to act according to the action plan generated by the action plan generation unit 130. Specifically, the action control unit 140 controls the traveling driving force output device 200, the brake device 210, and the steering device 220 so that the vehicle M passes the target track generated by the action plan generation unit 130 at the scheduled time. The action control unit 140 controls, for example, the traveling driving force output device 200 and the brake device 210 based upon the speed element associated with the target track, or controls the steering device 220 according to a curvature degree of the target track.

Each functional unit of the automatic driving control device 100 is realized, for example, by a Central Processing Unit (CPU) executing a predetermined program (software). Further, a part or all of the functional units of the automatic driving control device 100 may be realized by hardware such as Large Scale Integration (LSI), an Application Specific Integrated Circuit (ASIC), a Field-Programmable Gate Array (FPGA), a Graphics Processing Unit (GPU), or the like, and for example, the storage device for storing the second map information 150 and the high-precision position recognition unit 120 may be realized by a Map Positioning Unit (MPU). Further, a part or all of the functional units of the automatic driving control device 100 may be realized by the cooperation of the software and the hardware.

[Parking Lot Managed by Parking Lot Management Device]

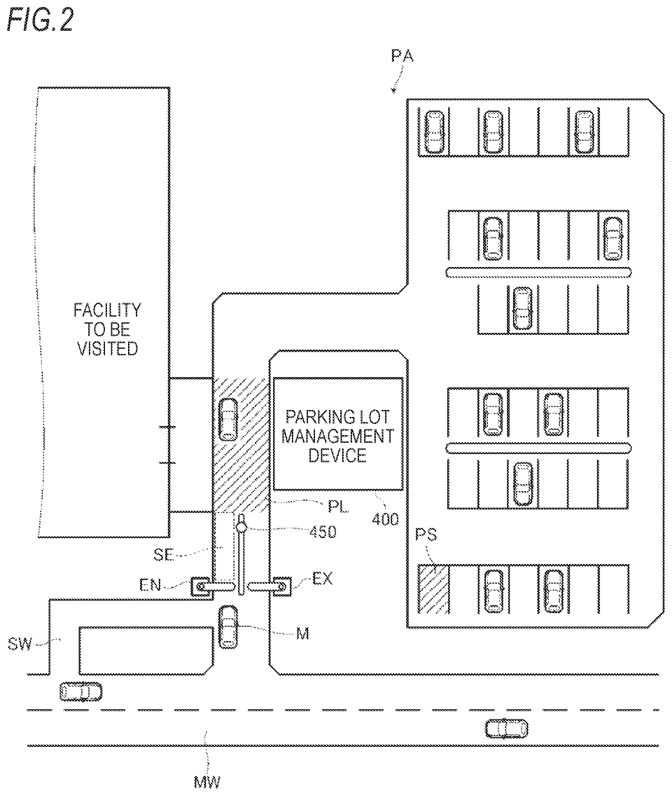

Next, an example of the parking lot PA will be described with reference to FIG. 2. As illustrated in FIG. 2, the parking lot PA is a parking lot managed by the parking lot management device 400 and is an automatic valet parking type parking lot provided as an annex in a visiting facility to be visited by the user. The parking lot PA includes a plurality of parking spaces PS capable of accommodating vehicles (for example, the vehicle M), and a platform PL provided in front of the plurality of parking spaces PS.

Further, an entrance gate EN through which the vehicle passes when entering the parking lot PA, and an exit gate EX through which the vehicle passes when exiting from the parking lot PA are provided in front of the platform PL. The vehicle entering the entrance gate EN and the vehicle exiting from the exit gate EX are monitored by a photographing device 450 at the entrance gate EN and the exit gate EX. The photographing device 450 is, for example, a digital camera or a digital video using a solid-state imaging device such as CCD, CMOS, or the like, and periodically transmits an image or a video captured thereby to the parking lot management device 400.

Further, an entrance to a branch road SW is provided in front of the entrance gate EN. The branch road SW is connected to a road MW on which the vehicle M coming to the parking lot PA has traveled. A vehicle canceling the entry into the parking lot PA right before the entrance gate EN can return to the road MW through the branch road SW.

Hereinafter, an example in which the user of the vehicle M uses the parking lot PA will be described.

Before using the parking lot PA, the user of the vehicle M makes a reservation for using the parking lot PA with respect to the parking lot management device 400 that manages the parking lot PA by using the terminal device 300. For example, the user of the vehicle M inputs a date and time of using the parking lot PA and identification information of the vehicle M into the terminal device 300 and transmits the pieces of information to the parking lot management device 400, thereby making a reservation for using the parking lot PA.

After that, when the date and time of the reservation are reached, the user of the vehicle M drives the vehicle M to right before the entrance gate EN and temporarily stops. The parking lot management device 400 allows or restricts the entry of the vehicle M into the parking lot PA.

The parking lot management device 400 does not open the entrance gate EN when restricting the entry of the vehicle M into the parking lot PA. In this case, the user of the vehicle M advances the vehicle M to the branch road SW.

The parking lot management device 400 opens the entrance gate EN when allowing the vehicle M to enter the parking lot PA. After the entrance gate EN is opened, the vehicle M performs automatic driving and moves to the platform PL. The user of the vehicle M gets off the vehicle M at the platform PL. A section from entering the parking lot PA to reaching the platform PL is defined as a section in which the user is restricted from getting on and off the vehicle M (hereinafter, also referred to as a getting-on-and-off restricted section SE).

After the user gets off the vehicle M, the vehicle M performs the automatic driving and starts a self-propelled entry event to move the vehicle M to the parking space PS in the parking lot PA. For example, the user transmits a request for starting the self-propelled entry event to the parking lot management device 400 by using the terminal device 300. In response to the request, the parking lot management device 400 instructs the vehicle M to perform the self-propelled entry event for allowing the vehicle M to be parked in a predetermined parking space PS. According to this instruction, the vehicle M moves to the parking space PS instructed by the parking lot management device 400 while being guided by the parking lot management device 400 and performing sensing by the camera 11, the radar device 12, or the finder 13.

Further, when the vehicle M exits from the parking lot PA, the vehicle M performs the automatic driving and performs a self-propelled exit event to move the vehicle M from the parking space PS to the platform PL. For example, the user transmits a request for starting the self-propelled exit event to the parking lot management device 400 by using the terminal device 300. In response to the request, the parking lot management device 400 instructs the vehicle M to perform the self-propelled exit event to move the vehicle M from the parking space PS where the vehicle M is parked to the platform PL. According to this instruction, the vehicle M moves to the platform PL while being guided by the parking lot management device 400 and performing sensing by the camera 11, the radar device 12, or the finder 13. The user of the vehicle M gets on the vehicle M at the platform PL and exits from the parking lot PA through the exit gate EX.

Further, the vehicle M may execute parking again, so-called “re-parking”, in which the parking position of the vehicle M being parked in the parking lot PA is changed to another parking position in the parking lot PA. This re-parking is appropriately executed by a control instruction by the parking lot management device 400 or a voluntarily automatic driving by the vehicle M itself.

Meanwhile, in order for the vehicle M to perform the automatic driving in the parking lot PA or the like, an automatic driving function of the vehicle M is required to be operated. For example, the vehicle M is provided with an operation switch for operating the automatic driving function and the user of the vehicle M can switch operation and non-operation of the automatic driving function of the vehicle M by operating the operation switch. As a result, the vehicle M operates the automatic driving function based upon the intention (the operation) of the user, thereby making it possible to perform the automatic driving. In other words, it is possible to prevent the automatic driving against the intention of the user.

Further, as the operation switch for operating the automatic driving function of the vehicle M, for example, an automatic moving switch for operating the automatic driving function (an automatic moving function) outside a predetermined area (for example, outside the parking lot PA. For example, an expressway), an automatic parking switch for operating the automatic driving function in a predetermined area (for example, the parking lot PA), or the like may be provided. The user of the vehicle M may be able to select an area in which the automatic driving function of the vehicle M is operated by operating the above-described switches. For example, in this case, when the user turns on the automatic parking switch and turns off the automatic moving switch, the user can operate only the automatic moving function in the predetermined area of the vehicle M (for example, the parking lot PA). Further, when either the automatic moving switch or the automatic parking switch is turned on, the automatic driving function in the predetermined area of the vehicle M (for example, the parking lot PA) may be operated. The automatic driving function of the vehicle M in the embodiment indicates, for example, the automatic moving function of the vehicle M in the predetermined area (for example, the parking lot PA).

[Parking Lot Management Device]

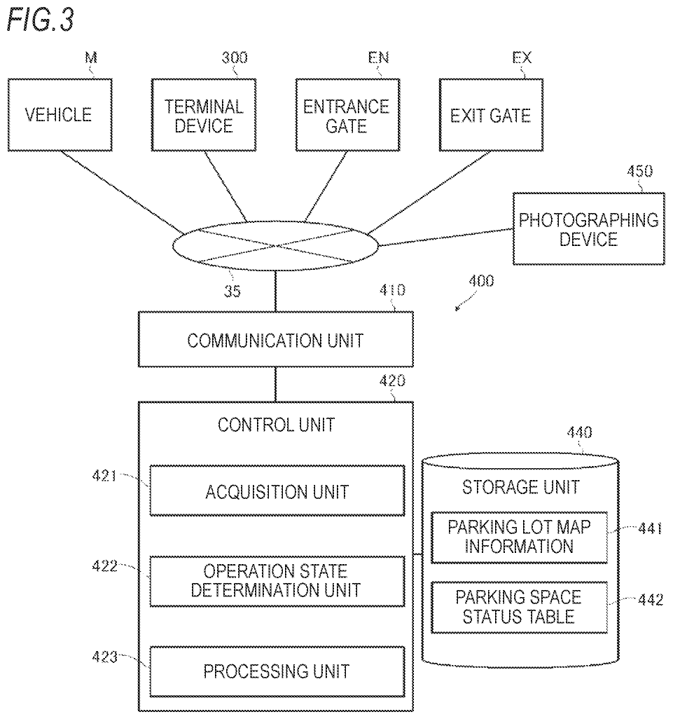

Next, an example of a configuration of the parking lot management device 400 will be described with reference to FIG. 3. As illustrated in FIG. 3, the parking lot management device 400 includes, for example, a communication unit 410, a control unit 420, and a storage unit 440. The control unit 420 includes, for example, an acquisition unit 421, an operation state determination unit 422, and a processing unit 423. Each component of the control unit 420 may be realized, for example, by a hardware processor such as a CPU or the like executing a program (software). A part or all of these components may be realized by hardware (including a circuit unit; circuitry) such as LSI, ASIC, FPGA, GPU, or the like, or may be realized by the cooperation of the software and the hardware. The program may be stored in advance in a storage device such as an HDD, a flash memory, or the like (a storage device including a non-transient storage medium), and may be stored in a removable storage medium such as a DVD, a CD-ROM, or the like (the non-transient storage medium) and then installed by attaching the storage medium to a drive device.

Information such as parking lot map information 441, a parking space status table 442, or the like is stored in the storage unit 440. The storage unit 440 is realized by an HDD, a flash memory, or the like.

The communication unit 410 wirelessly (for example, the network 35) communicates with the vehicle M, the terminal device 300, the entrance gate EN, the exit gate EX, and the photographing device 450. The control unit 420 guides the vehicle M to the parking space PS based upon the information acquired via the communication unit 410 and the information stored in the storage unit 440. The parking lot map information 441 is information that geometrically represents a structure of the parking lot PA. Further, the parking lot map information 441 includes a coordinate of each parking space PS.

The acquisition unit 421 acquires an operation state of the automatic driving function of the vehicle M. For example, the acquisition unit 421 acquires the operation state of the automatic driving function of the vehicle M from the vehicle M approaching the parking lot PA. Here, for example, the vehicle M approaching the parking lot PA can be defined as the vehicle M located within a predetermined distance from the entrance gate EN and the parking lot PA (for example, an outer edge portion of the parking lot PA). More specifically, for example, the vehicle M approaching the parking lot PA can be defined as the vehicle M that has arrived right before (immediately before) the entrance gate EN. That is, for example, the acquisition unit 421 acquires the information indicating the operation state of the automatic driving function of the vehicle M from the vehicle M temporarily stopped right before the entrance gate EN via the communication unit 410, thereby acquiring the operation state of the automatic driving function of the vehicle M. The operation state of the automatic driving function of the vehicle M approaching the parking lot PA is acquired in this manner, thereby making it possible to acquire the operation state of the automatic driving function of the vehicle M immediately before attempting to enter the parking lot PA.

Further, the acquisition unit 421 may acquire the operation state of the automatic driving function of the vehicle M before approaching the parking lot PA. For example, the acquisition unit 421 may acquire the information indicating the operation state of the automatic driving state of the vehicle M by communicating with the terminal device 300 or the like used for the use reservation when the reservation is made for the vehicle M to use the parking lot PA, thereby acquiring the operation state of the automatic driving function of the vehicle M before approaching the parking lot PA. Further, when the operation state of the automatic driving function of the vehicle M can be acquired in advance in this manner, the acquisition of the operation state when the vehicle M approaches the parking lot PA may be omitted. Further, for example, the acquisition unit 421 may acquire the operation state of the automatic driving function of the vehicle M based upon a recognition result or the like obtained by performing data processing on an image and a video captured by the photographing device 450.

The operation state determination unit 422 determines whether the automatic driving function of the vehicle M is in operation or in non-operation based upon the information indicating the operation state acquired by the acquisition unit 421. The operation state determination unit 422 determines, for example, whether the automatic driving function of the vehicle M approaching the parking lot PA is in operation or in non-operation.

The processing unit 423 performs processing of allowing or restricting the entry of the vehicle M into the parking lot PA based upon the determination result of the operation state determination unit 422. For example, the processing unit 423 performs the processing of allowing or restricting the entry of the vehicle M approaching the parking lot PA into the parking lot PA.

As the processing of allowing the entry into the parking lot PA (that is, entry into the parking lot PA), for example, processing of opening the entrance gate EN, processing of storing or setting allowance information for allowing the opening of the entrance gate EN, or the like can be included. Further, as the processing of restricting the entry into the parking lot PA, for example, processing of not opening the entrance gate EN, processing of storing or setting non-permission information for not allowing the opening of the entrance gate EN, or the like can be included.

For example, the processing unit 423 performs the processing of opening the entrance gate EN only when it is determined that the automatic driving function of the vehicle M approaching the parking lot PA is in operation. In this manner, since the entry of the vehicle M into the parking lot PA is allowed or restricted based upon the determination result of whether the automatic driving function of the vehicle M is in operation or in non-operation, it is possible to prevent the vehicle M, which may hinder smooth movement of other vehicles in the parking lot PA, from entering the parking lot PA, and to allow the vehicles to smoothly move in the parking lot PA. That is, since the entry of the vehicle M traveling by manual driving into the parking lot PA is prevented, the smooth movement of other vehicles in the parking lot PA is not hindered by a low driving skill and an erroneous driving operation of the user of the vehicle M.

Further, after performing the processing of allowing the vehicle M to enter the parking lot PA, and the processing unit 423 may perform processing of restricting the user from getting on and off the vehicle M in the getting-on-and-off restricted section SE (hereinafter, also referred to as getting-on-and-off restriction processing). That is, for example, the processing unit 423 may perform the getting-on-and-off restriction processing on the vehicle M when it is determined that the automatic driving function of the vehicle M approaching the parking lot PA is in operation.

An example of the getting-on-and-off restriction processing can include processing of instructing the vehicle M to be put in a state where a door and a window of the vehicle M cannot be opened. This processing is realized in such a manner that the vehicle M and the parking lot management device 400 communicate with each other via the network 35. When the getting-on-and-off restriction processing is performed, the user is restricted from getting on and off the vehicle M in the getting-on-and-off restricted section SE, thereby making it possible to prevent the smooth movement of other vehicles from being hindered by the user getting on and off the vehicle M in the getting-on-and-off restricted section SE.

Further, when performing the getting-on-and-off restriction processing, the processing unit 423 performs processing of notifying the user of the vehicle M who is restricted from getting on and off the vehicle M that getting on and off the vehicle M is restricted in the getting-on-and-off restricted section SE (hereinafter, also referred to as getting-on-and-off restriction notification processing). Examples of the getting-on-off restriction notification processing can include processing of displaying a message that getting on and off the vehicle M is restricted in the getting-on-and-off restricted section SE on a display installed near the entrance gate EN, processing of emitting, by the sound, the message from a speaker installed near the entrance gate EN, processing of displaying or emitting, by the sound, the predetermined message on the input and output device 20 of the vehicle M, processing of displaying or emitting, by the sound, the message on the input and output device 310 of the terminal device 300 of the user of the vehicle M, or the like. By performing the getting-on-and-off restriction notification processing, it is possible to notify the user of the vehicle M entering the parking lot PA in advance that getting on and off the vehicle M is restricted in the getting-on-and-off restricted section SE.

Further, if a predetermined event has occurred in the getting-on-and-off restricted section SE after the processing unit 423 performed the processing of allowing the vehicle M to enter the parking lot PA, the processing unit 423 performs processing of notifying the user of the vehicle M that the predetermined event has occurred in the getting-on-and-off restricted section SE (hereinafter, also referred to as predetermined event occurrence notification processing). That is, when it is determined that the automatic driving function of the vehicle M approaching the parking lot PA is in operation and the predetermined event occurs in the getting-on-and-off restricted section SE, the processing unit 423 may perform the predetermined event occurrence notification processing.

Further, the predetermined event occurrence notification processing may be performed during a temporary stop of the vehicle M before the vehicle M enters the parking lot PA. That is, as will be described later, for example, the processing unit 423 temporarily stops the vehicle M at a predetermined position such as right before the entrance gate EN or the like before the vehicle M enters the parking lot PA. While the vehicle M is temporarily stopped as described above, the processing unit 423 may perform the predetermined event occurrence notification processing.

By performing the predetermined event occurrence notification processing, it is possible to notify the user in advance that a predetermined event has occurred in a section from entering the parking lot PA to reaching the platform PL. An example of the predetermined event can include an event in which time required to pass through the getting-on-and-off restricted section SE is expected to be prolonged due to traffic congestion, breakdown, accident, or other causes of other vehicles passing through the getting-on-and-off restricted section SE. Further, another example of the predetermined event can also include presence of an obstacle (for example, a falling object and an animal) that hinders the vehicle from passing through the getting-on-and-off restricted section SE, deterioration in a road surface of the getting-on-and-off restricted section SE due to freezing and snow accumulation, or the like.

Determination of the presence or absence of the occurrence of the predetermined event can be realized, for example, by constantly or periodically imaging the getting-on-and-off restricted section SE with the photographing device 450 and then determining the existence of the vehicle in the getting-on-and-off restricted section SE (whether or not there are more than a predetermined number of vehicles, whether or not there are vehicles being stopped for a predetermined time or longer, or the like) based upon the image obtained by the photographing. Further, the processing unit 423 may determine whether or not the predetermined event has occurred based upon the vehicle information obtained by communicating with the vehicle existing in the getting-on-and-off restricted section SE. Here, the vehicle information is, for example, information indicating the speed, position, or the like of the vehicle.

After performing the predetermined event occurrence notification processing, the processing unit 423 performs processing of restricting the vehicle M from entering the parking lot PA when the user of the vehicle M performs an operation indicating that the user does not enter the parking lot PA (hereinafter, also referred to as an entry cancellation operation). Specifically, for example, when the user of the vehicle M approaching the parking lot PA performs the entry cancellation operation by using the terminal device 300 or the like, the processing unit 423 receives the above-described indication via the network 35. In that case, the processing unit 423 restricts the vehicle M from entering the parking lot PA by not opening the entrance gate EN. In this manner, when the user of the vehicle M performs the entry cancellation operation, it is possible to prevent the vehicle M from entering the parking lot PA against the intention of the user by restricting the vehicle M from entering the parking lot PA. For example, the processing unit 423 temporarily stops the vehicle M at a predetermined position such as right before the entrance gate EN or the like before the vehicle M enters the parking lot PA. Next, the processing unit 423 determines whether or not the entry cancellation operation is performed while the vehicle M is temporarily stopped in this manner.

As a situation where the user of vehicle M performs the entry cancellation operation, for example, there is a situation in which a user can't wait until the vehicle M reaches the platform PL due to the reason, such as that the user wants to go to a toilet immediately, that the user should return due to occurrence of an urgent business, or the like. When the above-described situation occurs, the user cancels the entry into the parking lot PA by performing the entry cancellation operation by using the terminal device 300 or the like, such that a course of the vehicle M can be changed to the branch road SW to go out to the road MW. Further, the entry cancellation operation is not limited to the terminal device 300 but may be received by the input and output device 20, the navigation device 40 (the input and output device 42), or an operation panel installed near the entrance gate EN, or the like.

Further, when determining that the automatic driving function of the vehicle M is in non-operation, the processing unit 423 performs processing of notifying the user of the vehicle M to operate the automatic driving function (hereinafter, also referred to as automatic driving operation notification processing). Examples of this processing can include processing of displaying a message urging the operation of the automatic driving function on the display installed near the entrance gate EN, processing of emitting, by the sound, the message from the speaker installed near the entrance gate EN, processing of displaying or emitting, by the sound, the message on the input and output device 20 of the vehicle M, processing of displaying or emitting, by the sound, the message on the input and output device 310 of the terminal device 300 of the user of the vehicle M, or the like. By performing the automatic driving operation notification processing, it is possible to urge the user of the vehicle M whose automatic driving function is in non-operation to operate the automatic driving function of the vehicle M.

Further, when the automatic driving function of the vehicle M is not operated within a predetermined time after executing the automatic driving operation notification processing, the processing unit 423 performs processing of notifying the user of the vehicle M of an operation content (for example, an operation of turning on the automatic parking switch described above) for operating the automatic driving function of the vehicle M (hereinafter, also referred to as operation content notification processing). Examples of this processing can include processing of displaying a message of the operation content on the display installed near the entrance gate EN, processing of emitting, by the sound, the message of the operation content from the speaker installed near the entrance gate EN, processing of displaying or emitting, by the sound, the message of the operation content on the input and output device 20 of the vehicle M, processing of displaying or emitting, by the sound, the message of the operation content on the input and output device 310 of the terminal device 300 of the user of the vehicle M, or the like. By performing the operation content notification processing, the user of the vehicle M whose automatic driving function is in non-operation can be notified of the operation content for operating the automatic driving function and can be urged to operate the automatic driving function of the vehicle M.

Further, when the automatic driving function of the vehicle M is not operated within the predetermined time after executing the automatic driving operation notification processing, the processing unit 423 performs processing of operating the automatic driving function of the vehicle M (hereinafter, also referred to as forced operation processing). This processing is realized by performing the communication between the vehicle M and the parking lot management device 400 via the network 35. Since the automatic driving function of the vehicle M approaching the parking lot PA is operated by performing the forced operation processing, it is possible to prevent a vehicle, which may hinder the smooth movement of other vehicles in the parking lot PA, from entering the parking lot PA.

Further, the processing unit 423 may perform processing of temporarily stopping the vehicle M at a predetermined position. Here, the predetermined position can be, for example, a position right before the entrance gate EN. In this case, the processing unit 423 can temporarily stop the vehicle M approaching the parking lot PA right before the entrance gate EN by closing the entrance gate EN. As described above, by temporarily stopping the vehicle M approaching the parking lot PA at the predetermined position, it is possible to prevent the vehicle M, which may hinder the smooth movement of other vehicles in the parking lot PA, from entering the parking lot PA.

In the embodiment, a physical gate (for example, a bar obstructing traffic) such as the entrance gate EN is provided to temporarily stop the vehicle M right before the entrance gate EN but the present invention is not limited thereto. For example, the processing unit 423 may temporarily stop the vehicle M by instructing the vehicle M having arrived at a predetermined position such as the entrance of the parking lot PA or the like to temporarily stop at the predetermined position. In this manner, the processing unit 423 can temporarily stop the vehicle M at the predetermined position without providing a physical gate (for example, the bar obstructing traffic) such as the entrance gate EN.

Further, when determining that the automatic driving function of the vehicle M approaching the parking lot PA is in operation, the processing unit 423 may further determine whether or not an occupant detection device of the vehicle M is normally in operation. Next, the vehicle M may be allowed to enter the parking lot PA only when the occupant detection device of the vehicle M is normally in operation.

Specifically, here, the occupant detection device is configured to include, for example, a camera that captures the inside of the vehicle M, a radar device that detects the presence or absence of an occupant of the vehicle M, a load sensor that detects a load on a seat of the vehicle M, a grip sensor detecting that the steering device 220 is gripped, or the like, and detects a state of the occupant of the vehicle M (for example, the presence or absence thereof). The occupant detection device has a self-diagnosis function and can detect an abnormality (not being able to normally detect the state of the occupant of the vehicle M) of the own device. The processing unit 423 inquires of the vehicle M approaching the parking lot PA about whether or not the occupant detection device of the vehicle M is normally in operation via the network 35 and opens the entrance gate EN when the operation of the occupant detection device is normal. In this manner, only when the occupant detection device of the vehicle M approaching the parking lot PA is normally in operation, the entrance gate EN is opened and the vehicle M is allowed to enter the parking lot PA, whereby it is possible to prevent the vehicle M whose occupant detection device is not normally in operation (for example, a vehicle which may hinder the smooth movement of other vehicles in the parking lot PA) from entering the parking lot PA.

Further, an operation on the vehicle M performed after the vehicle M having entered the parking lot PA may be invalidated. For example, the parking lot management device 400 instructs the vehicle M having entered the parking lot PA to invalidate the operation of the user. As a result, the operation of the user on the vehicle M having entered parking lot PA is invalidated, thereby making it possible to prevent the smooth movement of other vehicles in the parking lot PA from being hindered by an erroneous operation or the like by the user of the vehicle M.

[Entry Management Processing Performed by Parking Lot Management Device]

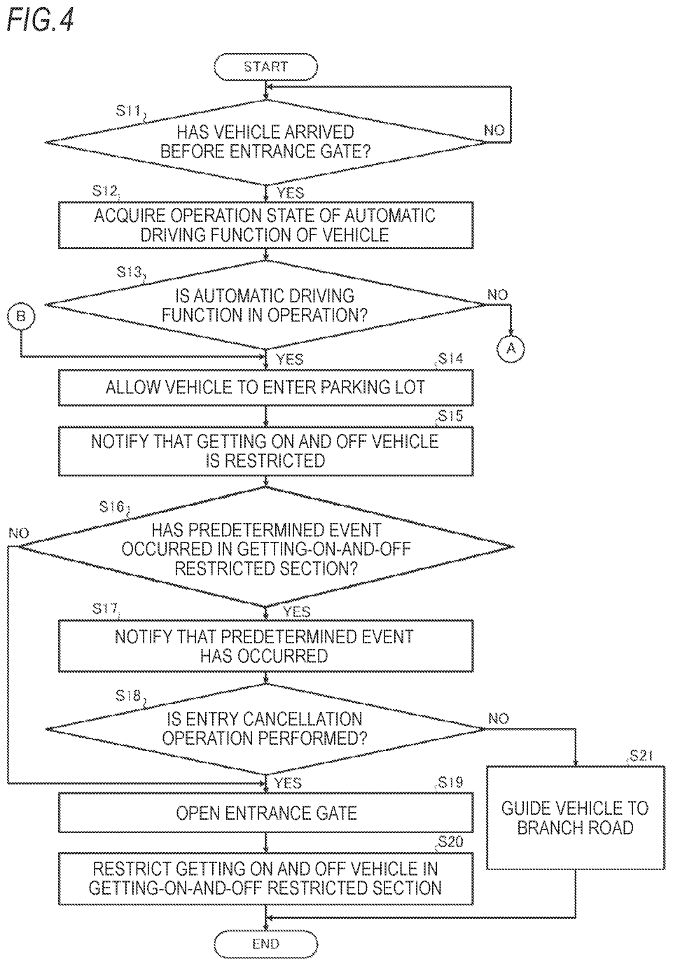

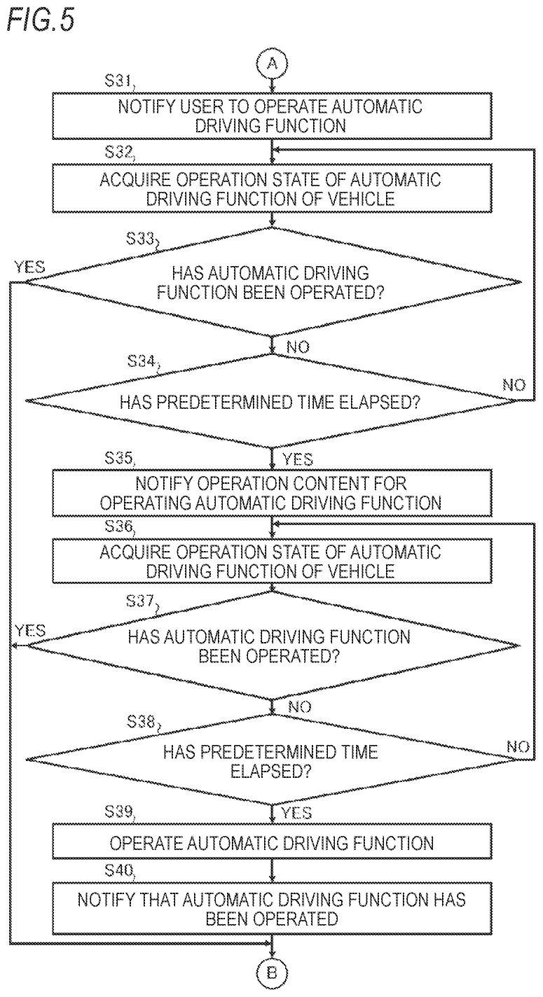

Next, an example of entry management processing performed by the parking lot management device 400 will be described with reference to FIGS. 4 and 5.

As illustrated in FIG. 4, the parking lot management device 400 determines whether or not the vehicle M arrives before the entrance gate EN (step S11). When it is determined that the vehicle M does not arrive before the entrance gate EN (NO in step S11), the parking lot management device 400 waits until the vehicle M arrives.

When it is determined that the vehicle M arrives before the entrance gate EN (YES in step S11), the parking lot management device 400 acquires the operation state of the automatic driving function of the vehicle M (step S12).

Next, the parking lot management device 400 determines whether or not the automatic driving function of the vehicle M is in operation based upon the processing result of step S12 (step S13). When it is determined that the automatic driving function is not in operation (NO in step S13), the parking lot management device 400 proceeds to the processing of step S31 illustrated in FIG. 5. On the other hand, when it is determined that the automatic driving function is in operation (YES in step S13), the parking lot management device 400 performs the processing of allowing the vehicle M to enter the parking lot PA (step S14).

Next, the parking lot management device 400 notifies the user of the vehicle M that getting on and off the vehicle M is restricted in the getting-on-and-off restricted section SE (step S15). By this notification, the user can know in advance that getting on and off the vehicle M is restricted in the getting-on-and-off restricted section SE. As a result, the user can be prevented from being confused by restricting the user from getting on and off the vehicle M in the getting-on-and-off restricted section SE.

Next, the parking lot management device 400 determines whether or not a predetermined event such as a traffic jam or the like has occurred in the getting-on-and-off restricted section SE (step S16). When it is determined that the predetermined event has not occurred in the getting-on-and-off restricted section SE (NO in step S16), the parking lot management device 400 proceeds to the processing of step S19. On the other hand, when it is determined that the predetermined event has occurred in the getting-on-and-off restricted section SE (YES in step S16), the parking lot management device 400 notifies the user of the vehicle M that the predetermined event occurs in the getting-on-and-off restricted section SE (step S17). The user can recognize the current situation, before entering the parking lot PA by performing this processing, in which it is likely to take longer than usual to reach the platform PL even though the user enters the parking lot PA as it is, and thus, the user can appropriately select a coping action such as waiting for the entrance gate EN to be opened or performing the entry cancellation operation.

Next, the parking lot management device 400 determines whether or not the user of the vehicle M has performed the entry cancellation operation (step S18). When it is not determined that the entry cancellation operation has been performed (YES in step S18), the parking lot management device 400 performs processing of opening the entrance gate EN (step S19). By performing this processing, the vehicle M can enter the parking lot PA. Next, when the vehicle M enters the parking lot PA through the entrance gate EN, the parking lot management device 400 restricts the user from getting on and off the vehicle M in the getting-on-and-off restricted section SE (step S20) and terminates the processing illustrated in FIG. 4. By executing the processing of step S20, even though the user performs an operation of opening a door and a window of the vehicle M, the door and the window thereof cannot be opened.

On the other hand, when it is determined that the entry cancellation operation has been performed (NO in step S19), the parking lot management device 400 does not perform the processing of opening the entrance gate EN. Next, the parking lot management device 400 guides the vehicle M to the branch road SW, for example, by displaying a predetermined message on the display installed near the entrance gate EN (step S21) and terminates the processing illustrated in FIG. 4.

Next, the processing illustrated in FIG. 5 will be described. The processing illustrated in FIG. 5 is processing performed when it is determined that the automatic driving function of the vehicle M is not in operation (NO in step S13), in the processing of step S13 illustrated in FIG. 4.

The parking lot management device 400 notifies the user of the vehicle M to operate the automatic driving function (step S31). This notification urges the user to operate the automatic driving function of the vehicle M.

Next, the parking lot management device 400 acquires the operation state of the automatic driving function of the vehicle M (step S32).

Next, the parking lot management device 400 determines whether or not the automatic driving function of the vehicle M is operated based upon the processing result of step S32 (step S33). When it is determined that the automatic driving function is operated (YES in step S33), the parking lot management device 400 proceeds to the processing of step S14 illustrated in FIG. 4.

When it is determined that the automatic driving function is not in operation (NO in step S33), the parking lot management device 400 performs the processing of notifying the user of the vehicle M to operate the automatic driving function (step S31) and then determines whether or not a predetermined time has elapsed (step S34). When it is not determined that the predetermined time has elapsed (NO in step S34), the parking lot management device 400 repeats the processing of steps S32 and S33. Next, when it is determined that the predetermined time has elapsed (YES in step S34), the parking lot management device 400 notifies the user of the vehicle M of the operation content for operating the automatic driving function of the vehicle M (step S35). In this manner, the operation content for operating the automatic driving function of the vehicle M is notified of the user of the vehicle M whose automatic driving function is not in operation even though the predetermined time has elapsed after the notification was performed to operate the automatic driving function. Therefore, even a user who does not know the operation content for operating the automatic driving function of the vehicle M can operate the automatic driving function.

Next, the parking lot management device 400 acquires the operation state of the automatic driving function of the vehicle M (step S36).

Next, the parking lot management device 400 determines whether or not the automatic driving function of the vehicle M has been operated based upon the processing result of step S36 (step S37). When it is determined that the automatic driving function has been operated (YES in step S37), the parking lot management device 400 proceeds to the processing of step S14 illustrated in FIG. 4.

When it is determined that the automatic driving function is not in operation (NO in step S37), the parking lot management device 400 performs the processing of notifying the operation content for operating the automatic driving function (step S35) and then determines whether or not a predetermined time has elapsed (step S38). When it is not determined that the predetermined time has elapsed (NO in step S38), the parking lot management device 400 repeats the processing of steps S36 and S37. Next, when it is determined that the predetermined time has elapsed (YES in step S38), the parking lot management device 400 operates the automatic driving function of the vehicle M (step S39). In this manner, since the parking lot management device 400 executes the processing of forcibly operating the automatic driving function with respect to the vehicle M whose automatic driving function is not in operation even though the predetermined time has elapsed after the operation content for operating the automatic driving function was notified, it is possible to completely prevent the vehicle M whose automatic driving function is not in operation from entering the parking lot PA.

Next, the parking lot management device 400 notifies the user of the vehicle M that the automatic driving function is operated (step S40). By this notification, the user can know that the automatic driving function of his/her own vehicle M is operated.

After that, the parking lot management device 400 proceeds to the processing of step S14 illustrated in FIG. 4 and performs the processing of steps S14 to S20. By performing the processing of step S19 or S20, the entry management processing by the parking lot management device 400 ends.

The present invention is not limited to the above-described embodiment, and can be appropriately modified, improved, or the like. For example, in the above-described embodiment, an example in which the moving body is defined as the vehicle is described, but the present invention is not limited thereto. The idea of the present invention can be applied not only to the vehicle but also to a robot, a ship, an aircraft, or the like which is provided with a drive source and can be moved by the power of the drive source. That is, under the concept of the present invention, “traveling” can be extended to a concept of “moving”, and “automatic driving” can be extended to a concept of “automatic moving” or “autonomous moving”. Further, in the same manner, in the above-described embodiment, an example in which a predetermined area is defined as a parking lot is described, and the predetermined area may be a hangar, a berth, a parking apron (an apron), or the like.

Further, at least the following items are described in this specification. The components or the like corresponding to the above-described embodiments are shown in parentheses, and the present invention is not limited thereto.

(1) A predetermined area management device (parking lot management device 400) configured to manage a predetermined area (parking lot PA) into which a moving body (vehicle M) can enter, wherein the predetermined area is an area in which the entering moving body automatically moves, the predetermined area management device including:

an acquisition unit (acquisition unit 42) configured to acquire information indicating the operation state of an automatic moving function of the moving body;

an operation state determination unit (operation state determination unit 422) configured to determine whether the automatic moving function of the moving body is in operation or in non-operation based upon the operation state; and

a processing unit (processing unit 423) configured to perform processing of allowing or restricting the entry of the moving body into the predetermined area based upon the determination result of the operation state determination unit.

According to (1), since the entry of the moving body into the predetermined area is allowed or restricted based upon the determination result of whether the automatic moving function of the moving body is in operation or in non-operation, it is possible to prevent a moving body, which may hinder the smooth movement of other moving bodies in the predetermined area, from entering the predetermined area and to allow the moving bodies to smoothly move in the predetermined area.

(2) The predetermined area management device according to (1), wherein

when it is determined that the automatic moving function of the moving body is in operation, the processing unit performs the processing of allowing the moving body to enter the predetermined area.

According to (2), since the moving body is allowed to enter the predetermined area when it is determined that the automatic moving function of the moving body is in operation, it is possible to prevent a moving body, which may hinder the smooth movement of other moving bodies in the predetermined area, from entering the predetermined area and to allow the moving bodies to smoothly move in the predetermined area. (3) The predetermined area management device according to (2), wherein

a platform where a user can get on and off the moving body is provided in the predetermined area, and

after the processing of allowing the moving body to enter the predetermined area is performed and the moving body enters the predetermined area, the processing unit further performs processing, on the moving body, of restricting the user from getting on and off the moving body in a section until the moving body reaches the platform.

According to (3), since the user is restricted from getting on and off the moving body entering the predetermined area in the section until the moving body reaches the platform, it is possible to prevent the smooth movement of other moving bodies from being hindered by the user getting on and off the moving body in the section.

(4) The predetermined area management device according to (3), wherein

when performing the processing of restricting the user from getting on and off the moving body, the processing unit further performs processing of notifying the user of the moving body who is restricted from getting on and off the moving body that getting on and off the moving body is restricted.

According to (4), it is possible to notify the user in advance that getting on and off the moving body is restricted in the section until the moving body reaches the platform.

(5) The predetermined area management device according to (3) or (4), wherein

if a predetermined event has occurred in a section until the moving body reaches the platform after the processing of allowing the moving body to enter the predetermined area was performed, the processing unit further performs processing of notifying the user of the moving body who is restricted from getting on and off the moving body that the predetermined event has occurred in the section.

According to (5), it is possible to notify the user in advance that the predetermined event has occurred in the section until the moving body reaches the platform.

(6) The predetermined area management device according to (5), wherein

if the user of the moving body who is restricted from getting on and off the moving body performs an operation not to enter the predetermined area after it has been notified that the predetermined event occurred, the processing unit performs processing of restricting the moving body from entering the predetermined area.

According to (6), if the user performs the operation not to enter the predetermined area, the moving body is restricted from entering the predetermined area, thereby making it possible to prevent the moving body from entering the predetermined area against the intention of the user.

(7) The predetermined area management device according to any one of (1) to (6), wherein

when it is determined that the automatic moving function of the moving body is in non-operation, the processing unit further performs processing of notifying the user of the moving body to operate the automatic moving function.

According to (7), since the user of the moving body in which the automatic moving function is in non-operation is notified to operate the automatic moving function, the user can be urged to operate the automatic moving function.

(8) The predetermined area management device according to (7), where

when the automatic moving function of the moving body is not operated within a predetermined time after the processing unit has notified that the automatic moving function is required to be operated, the processing unit further performs processing of notifying the user of the moving body of an operation content for operating the automatic moving function.

According to (8), since the user of the moving body whose automatic moving function is in non-operation is notified of the operation content for operating the automatic moving function, the user can be urged to operate the automatic moving function.

(9) The predetermined area management device according to (8), wherein

when the automatic moving function of the moving body is not operated within a predetermined time after the processing unit has notified the operation content for operating the automatic moving function, the processing unit further performs processing of operating the automatic moving function of the moving body.

According to (9), since the automatic moving function of the moving body is operated, it is possible to prevent a moving body, which may hinder the smooth movement of other moving bodies in the predetermined area, from entering the predetermined area.

(10) The predetermined area management device according to any one of (1) to (9), wherein

the acquisition unit acquires information indicating the operation state from the moving body approaching the predetermined area.

According to (10), since the information indicating the operation state is acquired from the moving body approaching the predetermined area, it is possible to determine whether to allow or restrict the entry of the moving body into the predetermined area based upon the information indicating the operation state immediately before the moving body attempts to enter the predetermined area.

(11) The predetermined area management device according to any one of (1) to (10), wherein

the processing unit further performs processing of temporarily stopping the moving body at a predetermined position.

According to (11), since the moving body approaching the predetermined area is caused to temporarily stop at the predetermined position, it is possible to prevent a moving body, which may hinder the smooth movement of other moving bodies in the predetermined area, from entering the predetermined area.

(12) The predetermined area management device according to any one of (1) to (11), wherein

an operation on the moving body performed after the moving body enters the predetermined area is invalidated.

According to (12), it is possible to prevent the smooth movement of other moving bodies from being hindered in the predetermined area due to an erroneous operation by the user.

1. A predetermined area management device configured to manage a predetermined area into which a moving body can enter, the predetermined area being an area in which the entering moving body automatically moves, the predetermined area management device comprising:
an acquisition unit configured to acquire information indicating the operation state of an automatic moving function of the moving body;
an operation state determination unit configured to determine whether the automatic moving function of the moving body is in operation or in non-operation based upon the operation state; and
a processing unit configured to perform processing of allowing or restricting the entry of the moving body into the predetermined area based upon the determination result of the operation state determination unit.

2. The predetermined area management device according to claim 1, wherein
when it is determined that the automatic moving function of the moving body is in operation, the processing unit performs the processing of allowing the moving body to enter the predetermined area.

3. The predetermined area management device according to claim 2, wherein
a platform where a user can get on and off the moving body is provided in the predetermined area, and
after the processing of allowing the moving body to enter into the predetermined area is performed and the moving body enters the predetermined area, the processing unit further performs processing, on the moving body, of restricting the user from getting on and off the moving body in a section until the moving body reaches the platform.

4. The predetermined area management device according to claim 3, wherein
when performing the processing of restricting the user from getting on and off the moving body, the processing unit further performs processing of notifying the user of the moving body who is restricted from getting on and off the moving body that getting on and off the moving body is restricted.

5. The predetermined area management device according to claim 3, wherein
if a predetermined event has occurred in a section until the moving body reaches the platform after the processing of allowing the moving body to enter the predetermined area was performed, the processing unit further performs processing of notifying the user of the moving body who is restricted from getting on and off the moving body that the predetermined event has occurred in the section.

6. The predetermined area management device according to claim 5, wherein
if the user of the moving body who is restricted from getting on and off the moving body performs an operation not to enter the predetermined area after it has been notified that the predetermined event occurred, the processing unit performs processing of restricting the moving body from entering the predetermined area.

7. The predetermined area management device according to claim 1, wherein
when it is determined that the automatic moving function of the moving body is in non-operation, the processing unit further performs processing of notifying the user of the moving body to operate the automatic moving function.

8. The predetermined area management device according to claim 7, wherein
when the automatic moving function of the moving body is not operated within a predetermined time after the processing unit has notified that the automatic moving function is required to be operated, the processing unit further performs processing of notifying the user of the moving body of an operation content for operating the automatic moving function.

9. The predetermined area management device according to claim 8, wherein
when the automatic moving function of the moving body is not operated within a predetermined time after the processing unit has notified the operation content for operating the automatic moving function, the processing unit further performs processing of operating the automatic moving function of the moving body.

10. The predetermined area management device according to claim 1, wherein
the acquisition unit acquires the operation state from the moving body approaching the predetermined area.

11. The predetermined area management device according to claim 1, wherein
the processing unit further performs processing of temporarily stopping the moving body at a predetermined position.

12. The predetermined area management device according to claim 1, wherein
an operation on the moving body performed after the moving body enters into the predetermined area is invalidated.
